(19) United States
(12) Patent Application Publication
(10) Pub. No.: US 2005/0076230 A1
(43) Pub. Date: Apr. 7, 2005

(54) Fraud tracking cookie

(76) Inventors: George Redenbaugh, San Jose, CA (US); Donald J. DeBold, San Jose, CA (US); Niraj Kanthi, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/678,682

(22) Filed: Oct. 2, 2003

(51) Int. Cl. H04L 9/00

(52) U.S. Cl. 713/200

(57) ABSTRACT

An embodiment of the invention provides a method of improving accuracy in fraud screening for online transactions, including: providing a security cookie to a computer of a customer who accesses a website, where the security cookie includes a unique identifier (ID) that is assigned to the customer; and if the customer accesses the website at a subsequent time, checking if the customer has exceeded a velocity value based upon the unique ID of the user. If the customer has exceeded the velocity value, then the order is placed in an outsort queue for fraud analysis. Alternatively, if the customer has exceeded the velocity value, then the velocity value along with other indicators relating to the order are evaluated by an electronic commerce fraud detection module to determine if the order is to be placed in an outsort queue for fraud analysis. A velocity value may be defined as the number of orders placed by the customer to the website within a particular defined time period.

### TECHNICAL FIELD

Embodiments of the present invention relate generally to the fraud prevention methods. More particularly, embodiments of the present invention related to a fraud tracking cookie for use in online transactions.

### BACKGROUND

An incoming order (e.g., an order for a particular product or service) may be placed by a customer via an online shopping website or via a call-center. One example of an online shopping website is the HPShopping website from HEWLETT-PACKARD COMPANY at <www.hpshopping.com>. Currently, when an incoming order is made by a customer, the incoming order will be reviewed for potential fraud by having an analyst who will examine the dollar amount of the incoming order. As a result, this current method is unable to detect for fraudulent orders that may have lower dollar amounts.

Online shopping websites can be accessed by fraudsters who seek to commit fraudulent transactions. A fraudster may, for example, utilize a single personal computer (PC) to place multiple fraudulent orders by use of the online shopping website. In many cases, the Internet Protocol (IP) address that is used by the PC of the fraudster is dynamic, and this makes detection of the fraudulent transaction to be very difficult. As a specific example, the AMERICA-ON-LINE (AOL) web service assigns a new IP address to a user for each time that the user logs into the Internet and engages in a transaction in an online shopping website. Since a fraudster is dynamically assigned a new IP address for each log in occurrence, it is difficult to detect and to track the fraudster who will engage in a fraudulent transaction in the online shopping website.

Therefore, the current technology is limited in its capabilities and suffers from at least the above constraints.

### SUMMARY OF EMBODIMENTS OF THE INVENTION

In one embodiment of the invention, a method of improving accuracy in fraud screening for online transactions, includes: providing a security cookie (i.e., fraud cookie) to a computer of a customer who accesses a website, where the security cookie includes a unique identifier (ID) that is assigned to the customer; and if the customer accesses the website at a subsequent time, checking if the customer has exceeded a velocity value based upon the unique ID of the user. If the customer has exceeded the velocity value, then the order is placed in an outsort queue for fraud analysis. Alternatively, if the customer has exceeded the velocity value, then the velocity value along with other indicators relating to the order are evaluated by an electronic commerce fraud detection module to determine if the order is to be placed in an outsort queue for fraud analysis. A velocity value may be defined as the number of orders placed by the customer to the website within a particular defined time period.

In another embodiment, an apparatus for improving accuracy in fraud screening for online transactions, includes: a server configured to provide a security cookie to a computer of a customer who accesses a website, where the security cookie includes a unique identifier (ID) that is assigned to the customer. The server is also configured to check if the customer has exceeded a velocity value based upon the unique ID of the user, if the customer accesses the website at a subsequent time, checking.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a flowchart of a method in accordance with an embodiment of the invention.

FIG. 3 is a flowchart of a method in accordance with another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

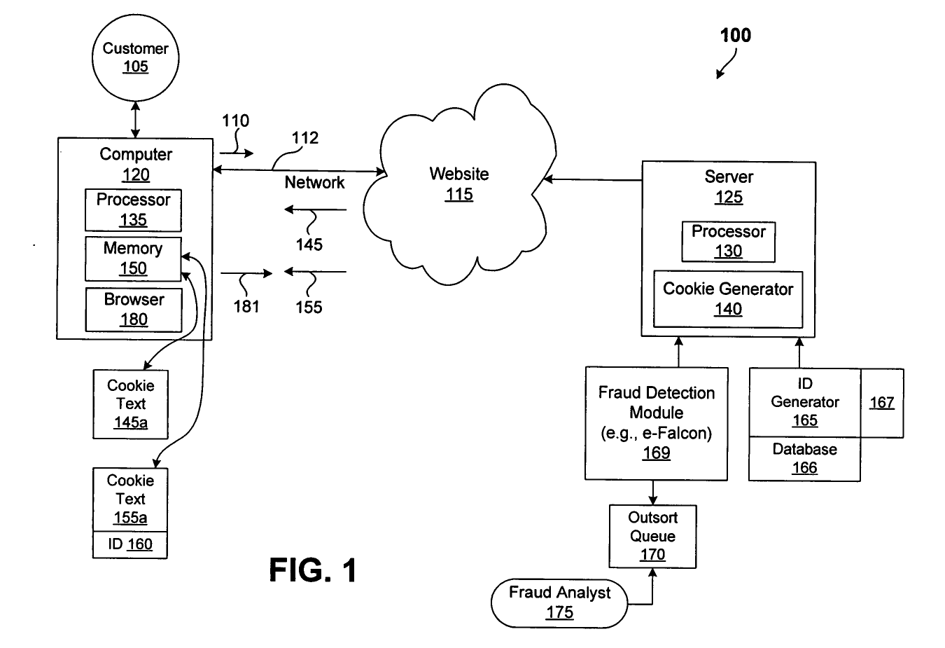

FIG. 1 is a block diagram of a system (or apparatus) 100 in accordance with an embodiment of the invention. A customer 105 may send an order 110 via a network 112 to an online shopping website 115. The order 110 may be, for example, an order for a particular product(s) and/or service(s). The online shopping website 115 may be, for example, an online shopping website provided by HEWLETT-PACKARD COMPANY at <www.HPShopping.com>, other online shopping websites from other vendors or companies, an internal company shopping website, or another type of online shopping website. The network 112 may be any suitable communication network such as, for example, a wide area network (e.g., the Internet) or a local area network (LAN).

Typically, to send an order 110 to the online shopping website 115, the customer 105 will use a computer 120 to access and place the order 110 on the website 115. Typically, a server 125 (or other suitable computing device) is used to implement the website 115 and to receive and process the order 110 from the customer 105. An embodiment of the invention provides a system 100 that permits the operator of the website 115 to determine if the customer 105 is sending an order(s) 110 that may be fraudulent. The system 100 can, therefore, reduce fraud and improve accuracy of fraud screening for transactions in the online shopping website 115.

The server 125 includes a processor 130 for executing various applications or programs in the server 125. Similarly, the computer 120 will also include a processor 135 for executing various applications or programs in the computer 120. Various known components that are used in the server 125 and in the computer 120 are not shown in FIG. 1 for purposes of describing the functionalities of embodiments of the invention.

For purposes of providing a security for a transaction that occurs in the online shopping website 115, a cookie generator application 140 in the server 125 permits the website 115 to generate a cookie 145 that is placed in memory 150 of the computer 120. The cookie 145 is generated by the cookie generator application 140 by use of standard cookie generation techniques. The cookie 145 prevents another individual to assume the session of the user 105 if the user 105 begins the transaction checkout process and then abandons his/her session. Typically, the cookie 145 is stored as a text file 145a in the computer memory 150.

As known to those skilled in the art, cookies are embedded in the HTML (Hypertext Markup Language) that flows between a user's computer and a web server. When a web server responds to a request for a document from a user's computer, the web server sends the cookie with the requested document. The cookie is typically a tagged string of text that contains data about the user's visit to the web site. If cookie caching has been enabled on the client browser in the user's computer, the client browser will store the cookie in the hard drive of the user's computer. Typically, the cookie is stored in a special file known as a “cookie list” or in a cookie directory. JavaScript programs can access the client's hard drive to read and write data, in order to store, modify, or even delete cookies.

Later, when the user returns to the web site from which the cookie originated, the previously-stored cookie will automatically be sent by the client browser to the web server in conjunction with the client request for a document. Typically, client browsers send cookies only to the web sites that created the cookies, and no web site can receive another web site's cookies. When the client browser requests a URL from an HTTP server, the client browser will match the URL against all stored cookies. If any of them match, a line containing the name/value pairs of all matching cookies will be included in the HTTP request. Additional details on cookies can be found in, for example, the following link: <www.cookiecentral.com> which is hereby fully incorporated herein by reference. A specification of the cookie protocol can be found in, for example, the following link: <www.netscape.com/newsref/std/cookie_spec.html> which is which is hereby fully incorporated herein by reference.

In an embodiment of the invention, the cookie generator application 140 generates a security cookie 155 (fraud tracking cookie) that contains a unique identification (ID) that is assigned to each customer who accesses the online shopping website 115. The security cookie 155 is generated by the cookie generator application 140 by use of standard cookie generation techniques. For example, the customer 105 who accesses the website 115 will have a security cookie 155 that the cookie generator 140 places in the memory 150 (of customer computer 120) as a security cookie text file 155a with a unique ID 160 that is associated with the customer 105. A second customer (not shown in FIG. 1) who accesses the website 115 will have another security cookie 155 that the cookie generator 140 places in the memory of the second user's computer as a security cookie text file with another unique ID that is associated with the second customer.

Typically, in an embodiment, the security cookie 145 is a persistent cookie. A persistent cookie may contain information that identifies the user 105, such as after a user 105 registers on the website 115, a list of previous purchases used by “shopping cart” function in the website 115 to keep track of an order in progress, or simply information that speeds up the process when the generating website 115 is visited again by the user/customer 105.

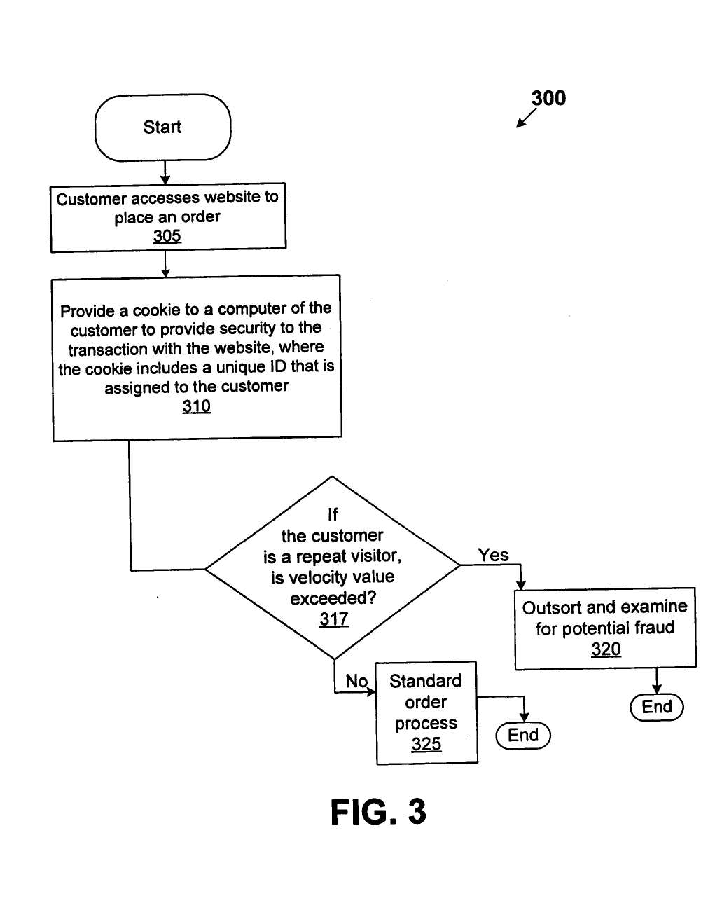

As also discussed in FIG. 3, in another embodiment of the invention, the security cookie 155 with the unique ID 160 can instead by integrated (nested) with the standard cookie 145 that provides security to transactions in the website 115.

An ID generator 165 and database 166 are used to assign a random unique ID 160 for each customer 105. The ID generator 165 and database 166 are manufactured by, for example, ORACLE CORPORATION. The random ID 160 is then placed in the security cookie 155.

The ID generator 165 embeds a random ID 160 as text within the cookie text 155a.

When the customer 105 who has been assigned a security cookie 145 with the unique ID 160 again subsequently visits the website 115, the processor 125 and cookie generator application 140 will look for the security cookie 155 (stored in the memory 150 of the customer's computer 120) from the client browser 181 request to the server 125. The processor 125 and cookie generator application 140 can detect for the unique ID 160 in the cookie text 155a by use of known techniques for identifying and reading cookies. When the unique ID 160 is identified by the processor 125 and cookie generator application 140, the unique ID 160 is logged into the database 166 for each time that the customer 105 visits the website 115, in order to keep track of the number of times that the customer 105 has visited the website 115 and attempted to send an order 110. If the customer 105 with a particular unique ID 160 has logged into the website 115 and attempted to send a given number of orders 110 within a particular time frame, then a possible indicator of transaction difficulty or potential fraud activity may be present. For example, if the customer 105 with a particular unique ID 160 has logged into the website 115 and has reached a particular unusual “velocity value”, then the order 110 will be placed in an outsort queue 170 and a fraud analyst 175 will evaluate the order 110 for potential fraud. A velocity value can be defined as, for example, a number of orders 110 placed by the customer 105 to the website 115 within a particular defined time period. An example of an unusual velocity value is if the customer 106 has attempted to send three (3) or more orders within a forty-eight (48) hour time period. The velocity value above can be defined in other order amounts and in the time period lengths. A counter and timer 167 may be used to track the number of customer order attempts within a defined time period, so that an unusual velocity value can be detected. The counter and timer 167 may be integrated with or can function with the ID generator 165.

Of course, the velocity value above may just be one factor that is used in order to determine if an order 110 should be placed in the outsort queue 170 for examination for potential fraud. Other indicators relating to the order 110 may be used, along with the velocity value, to determine if an order should be placed in the outsort queue 170. In an embodiment, the velocity value is considered, along with other indicators, by an e-commerce fraud detection module 169 such as, for example, the eFalcon product from Fair, Issac and Company, San Rafael, Calif. The fraud detection module 169 compares the transaction to general fraud patterns to determine if the order 110 should be placed in the outsort queue 170. However, it is within the scope of embodiments of the invention to omit the fraud detection module 169 (or to use the fraud detection module 169 as an option), when determining if an order 110 is to be placed in the outsort queue 170.

In an embodiment, each unique ID 160 that already has been assigned to a customer 105 is tagged in the database 166 by the ID generator 165, so that ID generator 165 can track the IDs 160 that have already been assigned and so that the same unique ID 160 is not assigned to multiple customers 105. As a result, each customer 105 will be assigned a different and unique ID 160 by the ID generator 165. Other known data management techniques may be used within the scope of embodiments of the invention to track the IDs 160 that have already been assigned to customers 105 and to prevent the assignment of the same ID 160 to multiple customers 105.

One method of examining an order 110 for potential fraud is by determining if the order is a high risk order, medium risk order, or low risk order. If an order is outsorted in outsort queue 170, then the order can then be evaluated for risk related to fraudulent activity. After an order 110 is categorized as a high risk order, medium risk order, or low risk order, then a set of information may be used to determine if the order is related to a potential fraudulent activity based upon the categorization of the order 110. Of course, other suitable methods may be used to evaluate an order for potential fraud activity, after the order 110 is placed in the outsort queue 170.

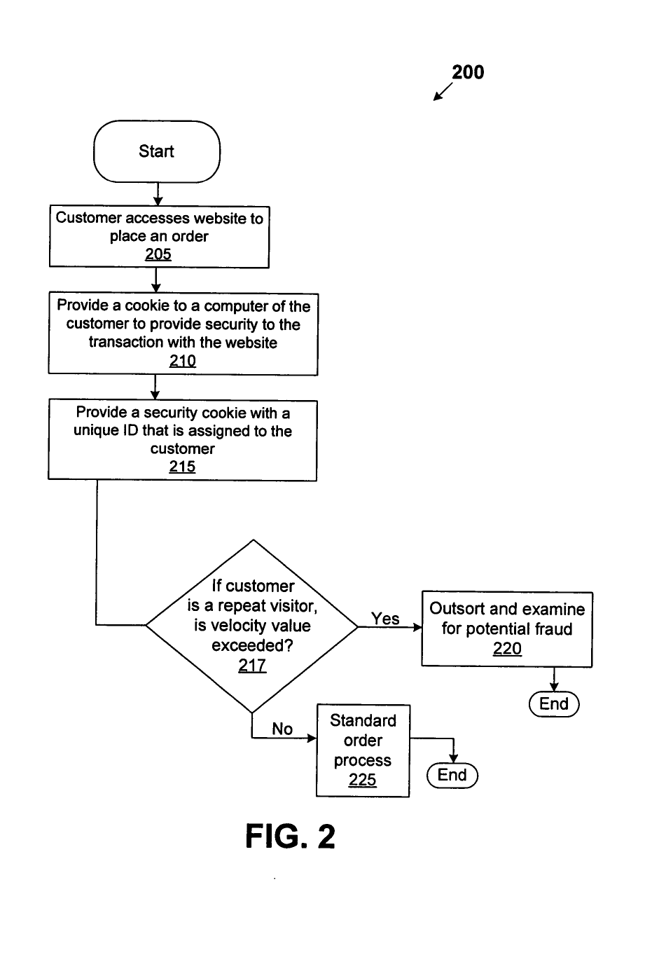

FIG. 2 is a flowchart illustrating a method 200 for improving accuracy in fraud screening, in accordance with an embodiment of the invention. A customer first accesses (205) a website to place an order in an online transaction. The website will provide (210) a cookie to a computer of the customer to provide security to the transaction of the customer with the website, in response to the customer's access of the website. The website will also provide (215) a security cookie (i.e., fraud cookie) that includes a unique ID that is assigned to the customer, if the customer is accessing the website for the first time. Each customer is assigned a different ID. For a customer who had previously visited the website, a determination (217) if the customer has exceeded a velocity value. The revisiting customer can be identified based upon the unique ID that has been previously assigned to that customer. Thus, an embodiment of the fraud cookie permits the tracking of a single customer/user and overcomes the disadvantage of using IP addresses as tracking signatures. As previously noted above, the disadvantage of using IP addresses as tracking signatures is that most IP addresses that are used by dial up users (e.g., such as AOL users) are dynamic and can change each time that the dial up user connects on line.

Even if the customer logs in or registers with a different user name on the website, an embodiment of the security cookie will link the multiple user names to the same individual. It is noted that tracking an individual user by his/her user name or login name is another approach to the tracking of a user, but this is also an unreliable method because a user can reregister and use multiple login names. To overcome this problem, an embodiment of the fraud cookie links the multiple login names to a single user to enable velocity analysis on the user's order placement, regardless of the login name used (and assuming that the user uses the same computer for each occurrence of user registration). The fraud cookie links the multiple login names to a single user regardless of the login name use by, for example, assigning a unique ID 160 for each particular computer 120. Therefore, even if a user with multiple login accounts does not place several orders in a short period of time and does not trigger the velocity detector (as typically implemented by the counter 167, ID generator 165, and database 166), the fact that a single user is placing orders via multiple accounts over a longer period of time (as opposed to a shorter time period such as 3 days) is in itself a suspicious activity that could factor into a fraud risk score for analysis by the fraud analyst.

In step (217), typically a check is made if the velocity value is exceeded. For example, if the customer has visited the website at a particular number of times within a given time period, then the customer has exceeded a velocity value. As a particular example, if the customer has attempted to send three (3) or more orders within a forty-eight (48) hour time period, then the customer has exceeded the velocity value. The velocity value above can be defined in other order amounts and in the time period lengths. If the velocity value has been exceeded, then the order is placed (220) in an outsort queue for examination for potential fraud. As an example, a fraud analyst may examine an order in the outsort queue for potential fraud.

However, as also noted above, if a single user is placing orders via multiple accounts over a longer period of time, then the velocity value is defined to also have been exceeded, and the order is also placed (220) in the outsort queue for examination for potential fraud.

If the velocity value has not been exceeded in step (217), then the order is processed (225) in accordance with a standard processing procedure that is defined by the owner of the website. In another embodiment, the velocity value is used, along with other indicators, by an e-commerce fraud detection module to determine if the order should be placed in the outsort queue for examination for potential fraud.

FIG. 3 is a flowchart illustrating a method 300 for improving accuracy in fraud screening, in accordance with an embodiment of the invention. A customer first accesses (305) a website to place an order in an online transaction. The website will provide (310) a cookie to a computer of the customer to provide security to the transaction of the customer with the website, in response to the customer's access of the website. In an embodiment, the cookie will include a unique ID that is assigned to the customer, if the customer is accessing the website for the first time. For a customer who had previously visited the website, a determination (317) if the customer has exceeded a velocity value. For example, if the customer has visited the website at a particular number of times within a given time period, then the customer has exceeded a velocity value. As a particular example, if the customer has attempted to send three (3) or more orders within a forty-eight (48) hour time period, then the customer has exceeded the velocity value. The velocity value above can be defined in other order amounts and in the time period lengths. If the velocity value has been exceeded, then the order is placed (320) in an outsort queue for examination for potential fraud. As an example, a fraud analyst may examine an order in the outsort queue for potential fraud.

However, as also noted above, if a single user is placing orders via multiple accounts over a longer period of time, then the velocity value is defined to also have been exceeded, and the order is also placed (320) in the outsort queue for examination for potential fraud.

If the velocity value has not been exceeded in step (317), then the order is processed (325) in accordance with a normal processing procedure that is defined by the owner of the website. In another embodiment, the velocity value is used, along with other indicators, by an e-commerce fraud detection module to determine if the order should be placed in the outsort queue for examination for potential fraud.

The various engines or modules discussed herein may be, for example, software, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of improving accuracy in fraud screening for online transactions, the method comprising:
providing a security cookie to a computer of a customer who accesses a website, where the security cookie includes a unique identifier (ID) that is assigned to the customer; and
if the customer accesses the website at a subsequent time, checking if the customer has exceeded a velocity value based upon the unique ID of the user.

2. The method of claim 1, further comprising:
if the customer has exceeded the velocity value, then placing the order in an outsort queue for fraud analysis.

3. The method of claim 1, further comprising:
if the customer has exceeded the velocity value, then evaluating, by an electronic commerce fraud detection module, the velocity value along with other indicators relating to the order to determine if the order is to be placed in an outsort queue for fraud analysis.

4. The method of claim 1, wherein the velocity value comprises:
a number of orders placed by the customer to the website within a particular defined time period.

5. The method of claim 1, wherein the security cookie is separate from a session cookie that provides security for transactions with the website.

6. The method of claim 1, wherein the unique ID is integrated in a session cookie that provides security for transactions with the website.

7. The method of claim 1, wherein a different unique ID is assigned to another user who accesses the website.

8. A method of improving accuracy in fraud screening for online transactions, the method comprising:
providing a security cookie to a computer of a customer who accesses a website, where the security cookie includes a unique identifier (ID) that is assigned to the computer; and
if the customer accesses the website at a subsequent time, checking if the customer has exceeded a velocity value based upon the unique ID, where the security cookie links multiple login names to a single customer to enable velocity analysis on an order placement from the customer, regardless of the login name that is used by the customer.

9. An apparatus for improving accuracy in fraud screening for online transactions, the apparatus comprising:
a server configured to provide a security cookie to a computer of a customer who accesses a website, where the security cookie includes a unique identifier (ID) that is assigned to the customer;
the server configured to check if the customer has exceeded a velocity value based upon the unique ID of the user, if the customer accesses the website at a subsequent time.

10. The apparatus of claim 9, wherein the server is configured to place the order in an outsort queue for fraud analysis, if the customer has exceeded the velocity value.

11. The apparatus of claim 9, wherein if the customer has exceeded the velocity value, then evaluating, by an electronic commerce fraud detection module, the velocity value along with other indicators relating to the order to determine if the order is to be placed in an outsort queue for fraud analysis.

12. The apparatus of claim 9, wherein the velocity value comprises:
a number of orders placed by the customer to the website within a particular defined time period.

13. The apparatus of claim 9, wherein the security cookie is separate from a session cookie that provides security for transactions with the website.

14. The apparatus of claim 9, wherein the unique ID is integrated in a session cookie that provides security for transactions with the website.

15. The apparatus of claim 9, wherein a different unique ID is assigned to another user who accesses the website.

16. An apparatus for improving accuracy in fraud screening for online transactions, the apparatus comprising:
a server configured to provide a security cookie to a computer of a customer who accesses a website, where the security cookie includes a unique identifier (ID) that is assigned to the computer;
the server configured to check if the customer has exceeded a velocity value based upon the unique ID, if the customer accesses the website at a subsequent time, where the security cookie links multiple login names to a single customer to enable velocity analysis on an order placement from the customer, regardless of the login name that is used by the customer.

17. An apparatus for improving accuracy in fraud screening for online transactions, the apparatus comprising:
means for providing a security cookie to a computer of a customer who accesses a website, where the security cookie includes a unique identifier (ID) that is assigned to the customer; and
means for checking if the customer has exceeded a velocity value based upon the unique ID of the user, if the customer accesses the website at a subsequent time.

18. An article of manufacture, comprising:
a machine-readable medium having stored thereon instructions to:
provide a security cookie to a computer of a customer who accesses a website, where the security cookie includes a unique identifier (ID) that is assigned to the customer; and
check if the customer has exceeded a velocity value based upon the unique ID of the user, if the customer accesses the website at a subsequent time.
